(19) United States
(12) Patent Application Publication
(10) Pub. No.: US 2007/0172162 A1
(43) Pub. Date: Jul. 26, 2007

(54) Bearing structure

(75) Inventor: Viejita Liu, Hsin Chu Hsien (TW)

Correspondence Address: HDSL, 4331 STEVENS BATTLE LANE, FAIRFAX, VA, 22033, US

(73) Assignee: SonicEdge Industries Corporation

(21) Appl. No.: 11/336,794

(22) Filed: Jan. 23, 2006

(51) Int. Cl. F16C 33/10

(52) U.S. Cl. 384/291

(57) ABSTRACT

A bearing is provided with a central hole and at least one flowing channel. Both ends of the flowing channel are extended with a capillary groove and a sectional groove in communication with the central hole, respectively. The inner wall of the spindle or bearing pivotably connected into the central hole is circumferentially provided with a circumferential groove in communication with the capillary groove and the sectional groove. With such arrangement, a circulatory supply of lubricant can be produced between the spindle and the bearing. The lubricant does not leak out and thus the spindle rotates more smoothly.

### BACKGROUND OF THE INVENTION

1. Field of the Invention

The present invention relates to a bearing, and in particular to an improved bearing structure capable of producing circulatory supply of the lubricant between a spindle and the bearing.

2. Description of Prior Art

A rotor can smoothly rotate in the conventional motor since a bearing is arranged in the pivots between the spindle and the base, casing or sleeve. When the rotor is rotating, the bearing can reduce the energy loss of the spindle caused by the friction. Therefore, the bearing plays an important role on the smooth rotation of the rotor.

Bearings can be categorized into roller bearings, linear bearings, oil impregnated bearings, sleeve-type bearings etc. The types of bearings are selected according to the desired rotating speed of the rotor so as to meet the requirements of the designer.

The bearings which are the most often used in existing compact fans are the aforementioned oil impregnated bearings and sleeve-type bearings. These kinds of bearings are generally provided with a through hole at the center thereof. The through hole is adapted to be pivotably connected to the spindle of the rotor. Lubricant is filled with the gap between the bearing and the spindle, such that the spindle can smoothly rotate in the bearing.

Although the lubricant is filled within the bearing so as to let the spindle of the rotor smoothly rotate in the bearing, such a conventional bearing is not provided with a structure for recycling the lubricant in the bearing. As a result, when the spindle of the rotor has rotated in the bearing for a period of time, owing to the gravity, centrifugal force and internal pressure between the spindle and the bearing, the lubricant will be gradually flung out of the bearing due to the rotation of the spindle, causing the gradual leakage of the lubricant in the bearing and thus losing the lubricating effect. Even, the lubricant may be dried out, such that the spindle cannot smoothly rotate in the bearing. As a result, the spindle will be worn away due to the friction between the spindle and bearing, and the undesired noise is inevitably produced.

### SUMMARY OF THE INVENTION

The present invention is to solve the above drawbacks. To this end, the inventor re-designs the bearing and the spindle, such that a structure for circulatorily supplying oil is provided between the bearing and the spindle of the rotor. As a result, the spindle can smoothly rotate without serious wear and undesired noise.

the present invention provides an improved bearing structure, comprising:

a bearing provided with a central hole and at least one flowing channel, wherein both ends of the flowing channel are extended with a capillary groove and a sectional groove in communication with the central hole, respectively; and

a spindle provided with a spirally circumferential groove in communication with the capillary groove and the sectional groove.

### BRIEF DESCRIPTION OF THE DRAWINGS

FIG. 1 is a perspective view showing the appearance of a bearing according to a first embodiment of the present invention;

FIG. 2 is a cross-sectional view showing the bearing of FIG. 1;

FIG. 3 is a cross-sectional view showing the operation of the bearing of FIG. 1;

FIG. 4 is an exploded perspective view showing the appearance of a bearing according to a second embodiment of the present invention;

FIG. 5 is a cross-sectional view showing the operation of the bearing of FIG. 4;

FIG. 6 is a cross-sectional view showing a bearing according to a third embodiment of the present invention;

FIG. 7 is a perspective view showing the appearance of a bearing according to a fourth embodiment of the present invention;

FIG. 8 is a view showing the operation of the bearing of FIG. 7; and

FIG. 9 is a cross-sectional view showing a bearing according to a fifth embodiment of the present invention.

### DETAILED DESCRIPTION OF THE INVENTION

The detailed description and the technical contents of the present invention will be explained with reference to the accompanying drawings.

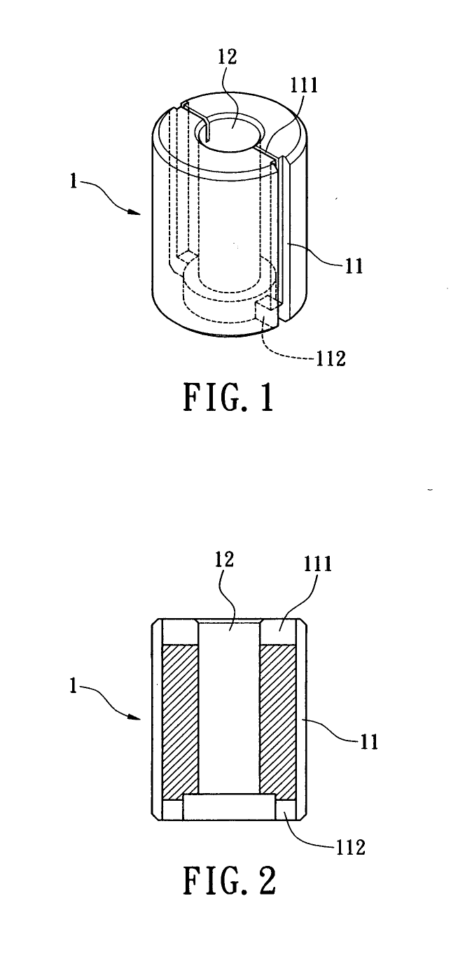

FIG. 1 is a perspective view showing the appearance of a bearing according to a first embodiment of the present invention, and FIG. 2 is a cross-sectional view showing the bearing of FIG. 1. The present invention is directed to a bearing provided with at least one flowing channel 11 and a central hole 12. The flowing channel 11 is extended with capillary grooves 111 and sectional grooves 112 in communication with the central hole 12.

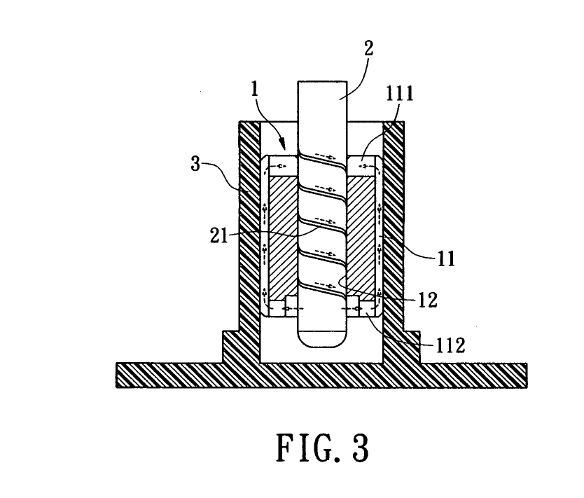

FIG. 3 is a cross-sectional view showing the operation of the bearing of FIG. 1. When in use, the bearing 1 is positioned into a sleeve 3, and a spindle 2 is pivotably connected into the central hole 12 of the bearing 1. The spindle 2 is circumferentially provided with a circumferential groove 21 in communication with the flowing channel 11. The circumferential groove 21 is spirally provided on the surface of the spindle 2 (alternatively, the circumferential groove 21 can be provided on the inner wall of the central hole 12 of the bearing 1, which will be described later). When the spindle 2 rotates, the lubricant in the bearing 1 is pressed downwardly along the spiral circumferential groove 21 of the spindle 2 and flows out via the sectional groove 112 of the flowing channel 11. As a result, the lubricant is absorbed into the capillary groove 111 via the flowing channel 11, and then into the gap between the bearing 1 and the spindle 2 via the capillary groove 11, producing a circulatory supply of lubricant. Therefore, no matter the bearing 1 is used in an upright, horizontal or inclined position, the capillary action of the capillary groove 11 can overcome the gravity and force the lubricant to recycle. As a result, a circulatory supply of lubricant can be produced between the spindle 2 and the bearing 1, resulting in a more smooth rotation of the spindle 2.

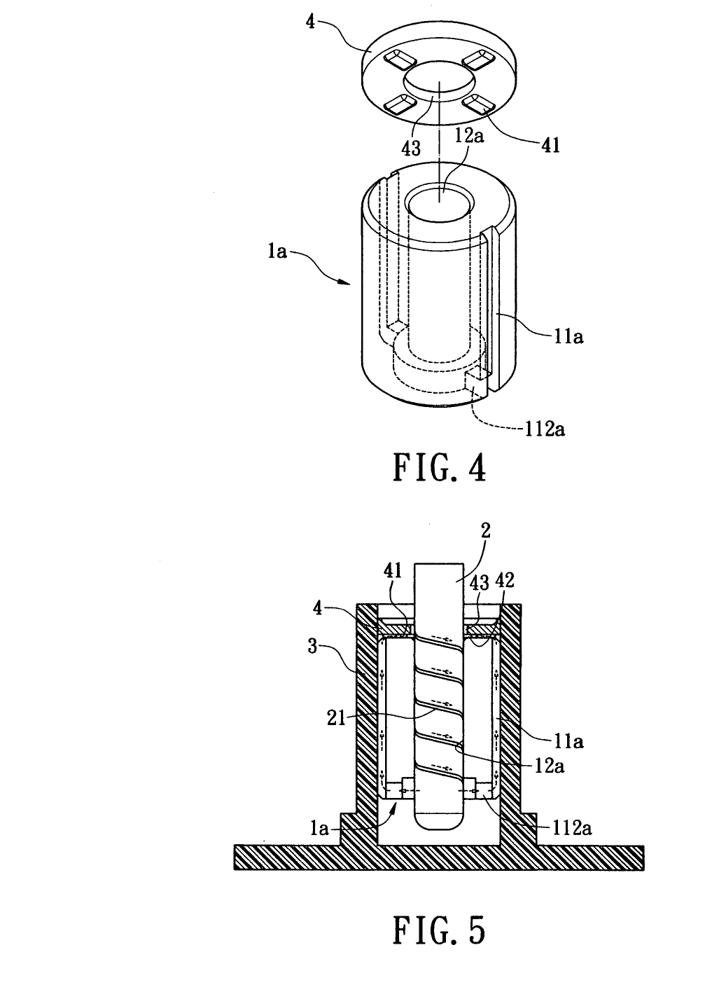

FIG. 4 is an exploded perspective view showing the appearance of a bearing according to a second embodiment of the present invention, and FIG. 5 is a cross-sectional view showing the operation of the bearing of FIG. 4. The bearing 1a of the present invention is provided with at least one flowing channel 11a. The bottom of the flowing channel 11a is extended with a sectional groove 112a in communication with the central hole 112a. The top end of the bearing is provided with a sealing cover 4 having a central hole 43. The surface of the sealing cover 4 corresponding to the bearing 1a is provided with a plurality of projecting portions 41, such that a capillary gap (such as capillary groove) 42 is formed between the sealing cover 4 and the bearing 1a.

When the spindle 2 rotates, the lubricant in the bearing 1a is pressed downwardly along the spiral circumferential groove 21 of the spindle 2 and flows out via the sectional groove 112a. As a result, the lubricant is absorbed into the gap 42 between the sealing cover 4 and the bearing 1a via the flowing channel 11a, and then into the bearing 1a via the gap 42. Therefore, no matter the bearing 1a is used in an upright, horizontal or inclined position, the capillary action of the gap 42 can overcome the gravity and force the lubricant to recycle. As a result, a circulatory supply of lubricant can be produced between the spindle 2 and the bearing 1a, resulting in a more smooth rotation of the spindle 2.

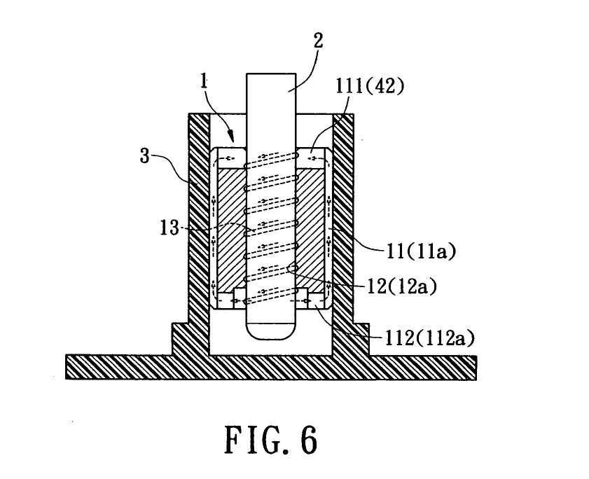

FIG. 6 is a cross-sectional view showing a bearing according to a third embodiment of the present invention. In the present embodiment, the circumferential groove 13 is circumferentially provided on the inner wall of the central hole 12 (or 12a) of the bearing 1 (or 1a). When the spindle 2 rotates, the lubricant in the bearing 1 (or 1a) is pressed downwardly along the circumferential groove 13 and flows out via the sectional groove 112 (or 112a). As a result, the lubricant is absorbed into the capillary groove 111 (42) via the flowing channel 11a, and then into the bearing 1 (or 1a) via the capillary groove 111 (or 42). Therefore, no matter the bearing 1 (or 1a) is used in an upright, horizontal or inclined position, the capillary action of the capillary groove 111 (42) can overcome the gravity and force the lubricant to recycle. As a result, a circulatory supply of lubricant can be produced between the spindle 2 and the bearing 1 (or 1a), resulting in a more smooth rotation of the spindle 2.

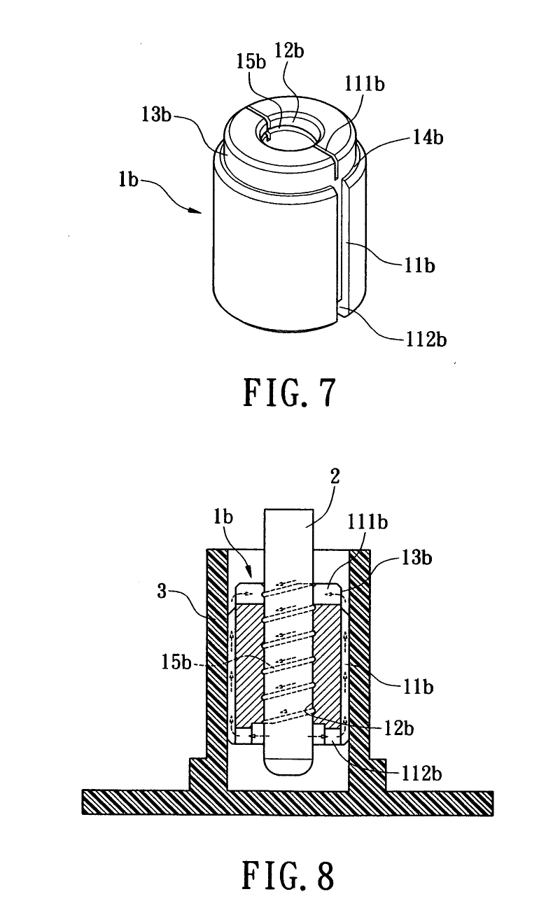

FIG. 7 is a perspective view showing the appearance of a bearing according to a fourth embodiment of the present invention, and FIG. 8 is a view showing the operation of the bearing of FIG. 7. The bearing 1b disclosed in the present embodiment is provided with at least one flowing channel 11b and a central hole 12b. The bottom of the flowing channel 11b is extended with a sectional groove 112b in communication with the central hole 12b. A projecting shaft is extended from the bearing 1b. A drop gap 14b is formed between the outer surface of the projecting shaft 13b and the outer surface of the bearing 1b. A capillary space is formed between the drop gap 14b and the inner wall of the sleeve 3. The projecting shaft 13b is provided with a capillary groove 111b in communication with the central hole 12b. A spiral circumferential groove 15b is provided on the inner wall of the central hole 12b (alternatively, the circumferential groove can be provided on the spindle).

When the spindle 2 rotates, the lubricant in the bearing 1b is pressed downwardly along the circumferential groove 15b. As a result, the lubricant is absorbed into the flowing channel 1b via the sectional groove 112b, and then into the capillary space formed between the drop gap 14b and the inner wall of the sleeve 3 via the flowing channel 1b. Next, the lubricant is absorbed into the capillary groove 111b via the capillary space, and into the central hole 12b via the capillary groove 111b. Therefore, no matter the bearing 1b is used in an upright, horizontal or inclined position, the capillary action existing in several places can overcome the gravity and force the lubricant to recycle. As a result, a circulatory supply of lubricant can be produced between the spindle 2 and the bearing 1b, resulting in a more smooth rotation of the spindle 2.

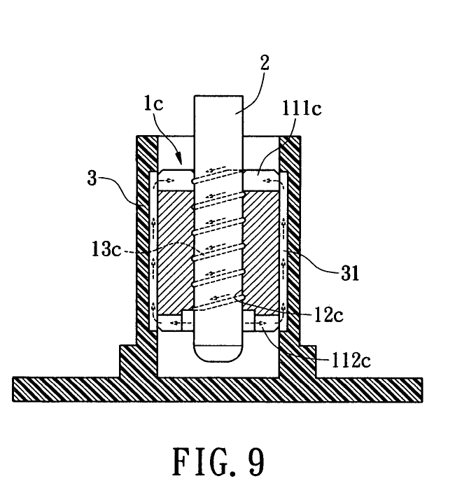

FIG. 9 is a cross-sectional view showing a bearing according to a fifth embodiment of the present invention. The bearing 1c disclosed in the present embodiment is provided with a central hole 12c and capillary grooves 111c and sectional grooves 112c in communication with the central hole 12c. The interior of the sleeve 3 attached to the aforementioned bearing 1c is provided with a flowing channel 31 in communication with the capillary grooves 111c and the sectional grooves 112c. A spiral circumferential groove 13c is provided on the inner wall of the central hole 12c (alternatively, the circumferential groove can be provided on the surface of the spindle).

The bearing 1c is positioned into the sleeve 3, and a spindle 2 is pivotably connected into the central hole 12c of the bearing 1c. When the spindle 2 rotates, the lubricant in the bearing 1c is pressed downwardly along the spiral circumferential groove 13c and flows out via the sectional groove 112c. As a result, the lubricant is absorbed into the flowing channel 31, into the capillary groove 111c, and then into the gap between the bearing 1c and the spindle 2 via the capillary groove 111c, producing a circulatory supply of lubricant. Therefore, no matter the bearing 1c is used in an upright, horizontal or inclined position, the capillary action of the capillary groove 111c can overcome the gravity and force the lubricant to recycle. As a result, a circulatory supply of lubricant can be produced between the spindle 2 and the bearing 1c, resulting in a more smooth rotation of the spindle 2.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A bearing structure, comprising a bearing having a central hole, wherein the bearing is provided with at least one flowing channel, and both ends of the flowing channel is extended with a capillary groove and a sectional groove in communication with the central hole.

2. A bearing structure, comprising:
a bearing having a central hole and at least one flowing channel, wherein both ends of the flowing channel are extended with a capillary groove and a sectional groove, respectively; and
a spindle pivotably connected into the central hole, wherein the spindle is circumferentially provided with a circumferential groove in communication with the capillary groove and the sectional groove.

3. The bearing structure according to claim 2, wherein the circumferential groove is spirally and circumferentially provided on the surface of the spindle.

4. A bearing structure, comprising:
a bearing provided with a central hole and at least one flowing channel, wherein the bottom of the flowing channel is provided with a sectional groove in communication with the central hole;
a sealing cover having a central hole and positioned to the top of the bearing, wherein a gap is formed between the sealing cover and the top of the bearing to communicate with the flowing channel.

5. The bearing structure according to claim 4, wherein the gap is a capillary groove.

6. The bearing structure according to claim 4, wherein the sealing cover is provided with a plurality of projecting portions.

7. A bearing structure, comprising:
a bearing provided with a central hole and at least one flowing channel, wherein the bottom of the flowing channel is provided with a sectional groove in communication with the central hole;
a sealing cover having a central hole and positioned to the top of the bearing, wherein a gap is formed between the sealing cover and the top of the bearing to communicate with the flowing channel; and
a spindle pivotably connected into the central holes of the bearing and the sealing cover, wherein the spindle is circumferentially provided with a circumferential groove in communication with the gap.

8. The bearing structure according to claim 7, wherein the gap is a capillary groove.

9. The bearing structure according to claim 7, wherein the sealing cover is provided with a plurality of projecting portions.

10. The bearing structure according to claim 7, wherein circumferential groove is spirally and circumferentially provided on the surface of the spindle.

11. A bearing structure, comprising a bearing having a central hole, wherein the bearing is provided with at least one flowing channel, both ends of the flowing channel are provided with a capillary groove and a sectional groove in communication with the central hole, respectively, and the inner wall of the central hole is circumferentially provided with a circumferential groove.

12. A bearing structure, comprising:
a bearing having a central hole and at least one flowing channel, wherein the bottom of the flowing channel is provided with a sectional groove in communication with the central hole, and the inner wall of the central hole is circumferentially provided with a circumferential groove; and
a sealing cover having a central hole and positioned to the top of the bearing, wherein a gap is formed between the sealing cover and the top of the bearing to communicate with the flowing channel.

13. A bearing structure, comprising a bearing having at least one flowing channel, wherein the bottom of the flowing channel is extended with a sectional groove in communication with the central hole, a projecting shaft is extended form the bearing, a drop gap is formed between the outer surface of the projecting shaft and the outer surface of the bearing, after the bearing is assembled with the sleeve, a capillary space is formed between the drop gap and the inner wall of the sleeve, the projecting shaft is provided with a capillary groove in communication with the central hole, and the inner wall of the central hole is provided with a spiral circumferential groove.

14. The bearing structure according to claim 13, wherein the circumferential groove is spirally and circumferentially provided on the inner wall of the central hole.

15. A bearing structure, comprising:
a bearing having at least one flowing channel, wherein the bottom of the flowing channel is extended with a sectional groove in communication with the central hole, a projecting shaft is extended form the bearing, a drop gap is formed between the outer surface of the projecting shaft and the outer surface of the bearing, after the bearing is assembled with the sleeve, a capillary space is formed between the drop gap and the inner wall of the sleeve, the projecting shaft is provided with a capillary groove in communication with the central hole; and
a spindle pivotably connected into the central hole and provided with a circumferential groove.

16. The bearing structure according to claim 15, wherein the circumferential groove is spirally and circumferentially provided on the surface of the spindle.

17. A bearing structure, comprising:
a bearing provided with a central hole, wherein the bearing is provided with a capillary groove and a sectional groove in communication with the central hole, and the inner wall of the central hole is provided with a circumferential groove; and
a sleeve whose interior is provided with a flowing channel in communication with the capillary groove and the sectional groove.

18. The bearing structure according to claim 17, wherein the circumferential groove is spirally and circumferentially provided on the inner wall of the central hole.

19. A bearing structure, comprising:
a bearing having a central hole and provided with capillary grooves and sectional grooves in communication with the central hole;
a sleeve whose interior is provided with a flowing channel in communication with the capillary grooves and sectional grooves; and
a spindle pivotably connected into the central hole and provided with a circumferential groove.

20. The bearing structure according to claim 19, wherein the circumferential groove is spirally and circumferentially provided on the surface of the spindle.
